(19) United States
(12) Patent Application Publication
(10) Pub. No.: US 2004/0141522 A1
(43) Pub. Date: Jul. 22, 2004

(54) Communications protocol for wireless lan harmonizing the ieee 802.11a and etsi hiperla/2 standards

(76) Inventors: Yossi Texerman, Modiin (IL); Oren Davidi, Ramat Gan (IL)

Correspondence Address: Mark M Friedman, Bill Polkinghorn, Dicovery Dispatch, 9003 Florin Way, Upper Marlboro, MD, 20772, US

(21) Appl. No.: 10/344,163

(22) PCT Filed: Jul. 11, 2001
(86) PCT No.: PCT/US01/21796

(51) Int. Cl. H04J 3/16

(52) U.S. Cl. 370/466; 370/338

(57) ABSTRACT

A unified communications protocol for wireless local area networks (WLANs) (400) which provides for the fair co-existence of the IEEE 802.11a (“11a”) and HiPerLAN/2 (“HL2”), broadband communications standards. Wireless network devices (MT's) operating in accordance with 11a and HL2 may co-exist without interference by partitioning a 2 ms periodic lime domain, based on the HL2 standard, into a first slice for use by 11a MT's and a slice for use by HL2 devices. An Arbitrator entity (ARB) broadcasts the time slices periodically at an interval which is greater than or equal to the periodic time domain. A first access Point (E-AP) handles communication with the E-MT's, and a second Access Point (M-AP) handles communications with the e-MTSs and the M-MT's. In this manner, convergence is provided between 11a and HL2, providing users with the best or both worlds, e.g., full interoperability, QoS and co-existence.

### TECHNICAL FIELD OF THE INVENTION

The invention relates to wireless communications and, more particularly, to a communications protocol (standard) for wireless local area network (WLAN) applications, taking into account the IEEE 802.11a standard and the ETSI HiPerLAN/2 standard.

### BACKGROUND OF THE INVENTION

A local area network (LAN) is a network of independent computers, usually confined to a geographic area, such as a single building or a college campus. LANs can be small, linking as few as three computers, but often link hundreds of computers used by thousands of people. The development of standard networking protocols and media has resulted in worldwide proliferation of LANs throughout business and educational organizations.

Ethernet is the most popular physical layer LAN technology in use today. The Institute for Electrical and Electronic Engineers (IEEE) defines the Ethernet standard as IEEE Standard 802.3. This standard defines rules for configuring an Ethernet network as well as specifying how elements in an Ethernet network interact with one another. By adhering to the IEEE standard, network equipment and network protocols can communicate efficiently.

Ethernet uses Collision Sense Multiple Access with Collision Detection (CSMA/CD). When an Ethernet station is ready to transmit, it checks for the presence of a signal on the cable. If no signal is present then the station begins transmission, however if a signal is already present then the station delays transmission until the cable is not in use. If two stations detect an idle cable and at the same time transmit data, then a collision occurs. The two stations involved with the collision lay off transmitting again for a time interval which is randomly selected. If the collision occurs again, then the time interval is doubled, and if the collision happens repeatedly, an error is reported.

The ‘Ether’ part of Ethernet denotes that the system is not meant to be restricted for use on only one medium type. Copper cables, fibre cables and radio waves can be used.

A wireless LAN (WLAN) is a data transmission system designed to provide location-independent network access between computing devices by using radio waves rather than a cable infrastructure. The major motivation and benefit from WLANs is increased mobility. Untethered from conventional network connections, network users can move about almost without restriction and access LANs from nearly anywhere. Wireless LANs also offer the connectivity and the convenience of wired LANs without the need for expensive wiring or rewiring.

The 5 GigaHertz (GHz) band is of particular interest for high bandwidth WLAN products. Being spectrally clean and wide, the 5 GHz band attracts much attention as being the enabler of wide public acceptance for broadband WLAN products. In the US, the 5 GHz U-NII (Unlicensed National Information Infrastructure) band extends from 5.15 GHz to 5.825 GHz, and is divided into three parts (bands) with different allowed EIRP (Effective Isotropically Radiated Power) values. The 200 mW band provides for in-building operation. The 1 W band allows campus or small neighborhood services. The 4W band allows for services of up to approximately 10 km. The 5 GHz band is open in Europe, the United States and Japan. The current spectrum allocation at 5 GHz comprises 455 MHz in Europe, 300 MHz in the US, and 100 MHz in Japan.

Two WLAN standards (protocols) for the 5 GHz band have emerged, the IEEE 802.11a (Hereinafter referred to as “802.11” or “11a”) and HiPerLAN/2 (hereinafter referred to as “HL2”). A common view in the industry is that these two standards are in competition with one another. Whereas the Ethernet-based 11a standard is particularly well-suited to the business environment, the multimedia-based HL2 standard is particularly well-suited to the home environment. As the industry has learned from past experience, competing standards and uncertainties about standard adoption and interoperability issues can greatly adversely the proliferation of products.

### Protocol-Specific Definitions & Abbreviations

Each of the 11a and HL2 standards utilizes its own definitions and abbreviations. It is therefore useful, for purposes of this document, to establish a common terminology, as follows:

| | |
|---|---|
| Ethernet elements | 11a elements may be referred to as Ethernet elements. |
| Multimedia elements | HL2 elements may be referred to as Multimedia elements. |
| Co-existence | The ability of two wireless elements, each consistent with a |
| | different protocol both at the same frequency, to work |
| | adjacently without interference. |
| Partial Interoperability | The ability of two wireless elements, each consistent with a |
| | different protocol, to exchange information through a third |
| | element. |
| Full Interoperability | The ability of two wireless elements, each consistent with a |
| | different protocol, to exchange information directly. |
| Access Point | This term is used to describe a so-called “base station” in both |
| | the 11a and HL2 standard (s). With reference to the present |
| | invention, the following prefixes will be used. |
| E-AP | Ethernet Access Point (consistent with the 11a term-AP/PC) |
| M-AP | Multimedia Access Point (consistent with the HL2 term-AP/CC) |
| U-AP | Unified Access Point (a “coined” term) |
| Mobile Terminal | This term is used to describe all wireless network elements |
| | except the Access Point, including stationary terminals, in both |
| | the 11a and HL2 standard (s). With reference to the present |
| | invention, the following prefixes will be used. |
| E-MT | Ethernet Mobile Terminal (consistent with the 11a term-STA) |
| M-MT | Multimedia Mobile Terminal (consistent the HL2 term-MT) |
| U-MT | Unified Mobile Terminal (a “coined” term) |

### IEEE 802.11a (“11a”)

The IEEE 802.11 (“11a”) standard is a broadband communication standard for WLANs, and defines two pieces of equipment, a wireless station (STA, herein “MT”), which is usually a personal computer (PC) equipped with a wireless network interface card (MC), and an access point (AP), which acts as a bridge between the wireless and wired networks. An AP usually consists of a radio, a wired network interface (e.g., Ethernet), and bridging software conforming to the IEEE 802.1d bridging standard. The AP acts as the base station for the wireless network, aggregating access for multiple MTs onto the wired network. Wireless stations can be 802.11 PC Card, PCI, or ISA NICs, or embedded solutions in non-PC clients (such as an 802.11-based telephone handset).

The 11a standard defines two modes of operation—an infrastructure mode and an ad-hoc mode. In the infrastructure mode, the wireless network consists of at least one AP connected to the wired network infrastructure and a set of MTs. This configuration is called a Basic Service Set (BSS). An Extended Service Set (ESS) is a set of two or more BSSs forming a single subnetwork. Since most corporate wireless LANs require access to the wired LAN for services (file servers, printers, Internet links) they typically operate in infrastructure mode. The ad-hoc mode (also called peer-to-peer mode, or Independent Basic Service Set, IBS) is simply a set of wireless stations (MTs) that communicate directly with one another without using an AP or any connection to a wired network. This mode is useful for quickly and easily setting up a wireless network anywhere that a wireless infrastructure does not exist or is not required for services, such as in a hotel room, convention center, or airport, or where access to the wired network is barred (such as for consultants at a client site).

The 11 a standard includes both a physical (PHY) layer and a medium access control (MAC) layer of the network. Generally, the PHY layer handles the transmission of data between nodes, and the MAC layer is a set of protocols which is responsible for maintaining order in the use of a shared medium.

The 11a MAC layer is responsible-for how a wireless station (MT) associates with an access point (AP). When an MT enters the range of one or more APs, it chooses an AP to associate with (also called “joining the Basic Service Set”), based on signal strength and observed packet error rates. Once accepted by the AP, the MT tunes to the radio channel to which the AP is set. Periodically, the MT surveys all of the available channels in order to assess whether a different AP would provide it with better performance characteristics. If it determines that this is the case, the MT reassociates with the new AP, tuning to the radio channel to which that AP is set. Reassociation usually occurs because the MT has physically moved away from the original AP, causing the signal to weaken. In other cases, reassociation occurs due to a change in radio characteristics in the building, or due simply to high network traffic on the original access point. In the latter case this function is known as “load balancing,” since its primary function is to distribute the total WLAN load most efficiently across the available wireless infrastructure.

A MAC-layer problem specific to wireless LAN is the “hidden node” issue, in which two stations on opposite sides of an AP can both “hear” activity from the AP, but not from each other, usually due to distance or an obstruction. To address this issue, the 11a standard specifies an optional Request to Send/Clear to Send (RTS/CTS) protocol at the MAC layer. When this feature is in use, a sending station (MT) transmits an RTS and waits for the access point to reply with a CTS. Since all stations in the BSS can hear the access point, the CTS causes them to delay any intended transmissions, allowing the sending station to transmit and receive a packet acknowledgment without any chance of collision.

### HiperLAN/2 (HL2)

HL2 is a another wireless LAN standard which includes both a Physical (PHY) Layer and a Medium Access Control (MAC) layer, and other layers as described hereinbelow. HL2 provides high-speed communications with a bit rate of up to 54-Mbits/s between Mobile Terminals (MTs) and various broadband infrastructure networks. The HL2 standard relies on cellular networking topology combined with an ad-hoc networking capability. It supports two basic modes of operation: centralized mode and direct mode. The centralized mode is used in the cellular networking topology where each radio cell is controlled by an access point (AP) covering a certain geographical area. In this mode, a mobile terminal (MT) communicates with other mobile terminals (Ts) or with the core network via an AP. This mode of operation is mainly used in business applications, both indoors and outdoors, where an area much larger than a radio cell has to be covered. The direct mode is used in the ad-hoc networking topology, mainly in typical private home environments, where a radio cell covers the whole serving area. In this mode, mobile terminals (MTs) in a single-cell home “network” can directly exchange data.

The PHY layer maps MAC Protocol Data Units (PDUs) to PHY PDUs, and adds PHY signaling such as system parameters and headers intended for RF signal synchronization. The signal modulation is based on Orthogonal Frequency Division Multiplexing (OFDM) with several sub-carrier modulation and forward error correction combinations that allow to cope with various channel configurations.

An intermediate layer, the Channel Access and Control (CAC) sub-layer, deals with channel access signaling and protocol operation required to support packet priority. A pseudo-hierarchically independent access mechanism is achieved via active signaling in a listen-before-talk access protocol. This mechanism (Elimination-Yield Non-Preemptive Multiple Access, EY-NPMA) codes priority level selection and contention resolution into a single, variable length radio pulse preceding packet data. EY-NPMA provides good residual collision rate performance for even large numbers of simultaneous channel contenders.

The HL2 standard also includes a Data Link Control (DLC) layer. Two specifications address the basic part of the DLC layer. The first one includes the basic data transport functions consisting of Error Control protocol and Medium Access Control (MAC) protocol. The second specification defines the Radio Link Control (RLC) Sublayer that is used for exchanging data in the control plane between an access point (AP) and a mobile terminal (MT). Furthermore, two specifications are developed for Home and Business profiles of the DLC. The air interface of HL2 is based on Time Division Duplex (TDD) and dynamic Time Division Multiplex (TDMA).

The HL2 standard also specifies Convergence Layers (CLs). A CL has two main functions: Adapting service requests from higher layers to the services offered by the DLC and converting the higher layer packets with fixed or variable size into fixed-size DLC Service Data Units that is used within the DLC. Convergence layers have been developed for Ethernet (IP based) applications, cell based core networks as ATM and for IEEE1394 protocols and applications.

The HL2 standard defines a set of protocols (measurements and signaling) to provide support for a number of radio network functions, e.g. Dynamic Frequency Selection (DFS), link adaptation, handover, multi beam antennas and power control, where the algorithms are vendor specific. The supported radio network functions allow cellular deployment of HL2 systems with full coverage and high data rates in a wide range of environments. The system automatically allocates frequencies to each access point for communications. This is performed by the DFS, which allows several operators to share the available spectrum by avoiding the use of interfered frequencies.

Performance is one of the most important factors when dealing with wireless LANs. In contrast to other radio-based systems, data traffic on a LAN has a randomized bursty nature, which may cause serious problems with respect to throughput. Many factors have to be taken into consideration, when quality of service (QoS) is to be measured. Among these are the topography of the landscape in general, elevations in the landscape that might cause shadows where connectivity is unstable or impossible, environments with many signal-reflection surfaces, environments with many signal-absorbing surfaces, quality of the wireless equipment, placement of the wireless equipment, number of stations, proximity to installations that generate electronic noise, and many more.

To cope with the varying radio link quality (interference and propagation conditions), the HL2 standard uses a link adaptation (LA) scheme, the aim of which is keeping up communications link at low signal-to-interference ratios in order to maintain the QoS, and to trade off between communications range and data rate. Based on link quality measurements, the physical layer data rate is adapted to the current link quality. Transmitter power control is supported in both mobile terminal (uplink) and access point (downlink). The uplink power control is mainly used to simplify the design of the access point receiver by avoiding automatic gain control at access point. The main goal of downlink power control is to fulfill the regulatory requirements in Europe to decrease interference to other systems using the same 5 GHz band.

A typical HL2 MAC Frame is of 2 ms duration, and comprises the following functions/phases:

| | |
|---|---|
| BCH | Broadcast CHannel |
| FCH | Frame CHannel |
| ACH | Access feedback CHannel |
| DL | Downlink |
| DIL | Direct Link |
| UL | Uplink |
| RCH | Random Channel(s) |

### Frequency Sharing Rules (FSRs)

Both of the 11a and HL2 standards have chosen the same OFDM-based approach in the PHY layer. Therefore, harmonization of the PHY layer is relatively straightforward, and needs no further discussion. On the other hand, the 11a and HL2 standards have implemented very different solutions in the MAC layer. While the 11a standard CSMA/CA MAC is optimized for wireless data communication, providing simple and field proven solution for wireless Ethernet and IP, the HL2 standard, with its build-in support for quality of service (QoS), provides robust solution for wireless multimedia transmission.

HL2 is basically centrally controlled, with the AP/CC announcing the time structure at the beginning of each MAC frame. This is in marked contrast to CSMA/CA of the 11 a standard, which is essentially a simple Listen-Before-Talk scheme.

HL2 allows the dynamic allocating of new frequencies (Dynamic Frequency Selection, DFS), as well as Transmitter Power Control (TPC). In contrast thereto, 11a keeps operating at a single carrier frequency, once it has been selected. Both systems apply Link Adaptation (LA), which is a flexible interference-dependent selection of modulation and coding.

Both of the 11a and HL2 standards are intended to operate in the license exempt band 5.1 . . . 5.8 GHz in Europe, and similar U-NII bands in the US and Japan. There therefore exists a need for a set of frequency sharing rules (FSRs), or etiquettes, providing the fair co-existence of these two broadband communication standards.

This problem has been addressed in COEXISTENCE OF IEEE 802.11 AND ETSI BRAN HiperLAN/2: THE PROBLEM OF FAIR RESOURCE SHARING IN THE LICENSE EXEMPT BAND AT 5 GHz, Mangold, et al., IEEE Conference on Third Generation Wireless Communications, Jun. 14-16, 2000, San Francisco, USA, available online at <<http://www.comnets.rwth-aachen.de/cgi-bin/paper-download.p1?B1BID=MaHmaiWij-3G wireless2000&LANG=en&USER=smd>>, hereinafter referred to as “Mangold”.

Mangold describes a simulated scenario wherein an 802.11 AP communicates with two MTs which are each at a distance of a few meters from the 802.11 AP, and a nearby HL2 AP communicates with two MTs which are also each at a distance of a few meters from the AP, and both systems are transmitting their packets at the same frequency using the same carrier. As noted therein:

The 802.11 packets sent after carrier sensing and after Ready To Send (RTS) and Clear To Send (CTS) bursts very often interfere with the BCH PDU of HL2 at the beginning of the MAC frame. Once the BCH of the HL2 is corrupted, the related MAC frame gets lost and no traffic can be carried in the uplink (UL). This is due to the fact that the BCH of HL2 is interfered by many 802.11 packets. Although the whole transmission period of an 802.11 packet may fit into the not used parts of the HL2 frame, at least with small loads, i.e., longer periods in the HL2 MAC frame which are not used, the BCH is very often corrupted. And, if the traffic load in both systems is close to its maximum, the HL2 frame is substantially filled up, the 802.11 system will fail to operate and the HL2 system reaches nearly its maximum. It can therefore be seen that without appropriate FSRs, mutual interferences will lead to poor QoS for both system types.

Mangold discusses possible solutions to the problem, as follows.

In order to avoid the transmission of a competing 802.11 terminal in not used parts of the HL2 MAC frame, LA is applied and a modulation and coding scheme is selected that fills up the MAC frame as much as possible. If this measure does not suffice to fill the MAC frame completely, the AP would broadcast system related management information in the not used parts of the MAC frame to fill it completely and avoid a 802.11 terminal to start its own transmission. Since the random access slots of the RACH might be used in HL2, and could therefore allow the transmission of an 802.11 terminal, the AP will transmit negative acknowledgement (NAK) at the slot as soon as it has detected an unused random access slot. This could be performed by transmitting energy bursts after detecting that no access happened. No idle periods longer than the inter frame space necessary for starting a transmission of 802.11 occur, and the 802.11 systems do not interfere in times when HL2 is required to guarantee QoS for real-time traffic such as voice or multimedia.

Mangold proposes a transmission suppression mechanism, wherein the transmission of 802.11 frames will be suppressed by HL2, so that it will never have the chance to be used when operated in HL2 environment. Therefore, this is not a co-existence solution, it is merely an approach to interference avoidance (HL2 can be operated but 802.11 can not).

In parallel to HiPerLAN/2 standardization work, the Multimedia Mobile Access Communications (MMAC) Association in Japan has started to develop different high-speed radio access systems for business and home applications at 5 GHz. One of these systems for business applications in corporate and public networks is aligned with HiPerLAN/2 at both the PHY layer and the DLC layer. In addition, the PHY layer of IEEE 802.11 standard in the 5 GHz band is harmonized with that of HiPerLAN/2.

### General Glossary

Unless otherwise noted, or as may be evident from the context of their usage, any terms, abbreviations, acronyms or scientific symbols and notations used herein are to be given their ordinary meaning in the technical discipline to which the invention most nearly pertains. The following glossary of terms is intended to lend clarity and consistency to the various descriptions contained herein, as well as in any prior art documents which may be cited:

| | |
|---|---|
| 3GPP | 3rd Generation Partnership Project |
| ACH | Access feedback CHannel |
| ACK | acknowledge/acknowledgment |
| AP | access point |
| ATM | Asynchronous Transfer Mode |
| BCH | Broadcast Channel |
| BPSK | Binary Phase Shift Keying |
| BRAN | Broadband Radio Access Networks |
| BSS | Basic Service Set |
| CC | Central Controller (HL2) |
| CCK | Complementary Code Keying |
| CEPT/ERC | Conférence Européenne |
| | des\ddot{ }Postes et Télécommunications |
| | (European Conference of Postal |
| | and Telecommunications Administrations)/ |
| | European Radiocommunication Committee |
| CRC | Cyclic Redundancy Check |
| CSMA/CA | Carrier Sense Multiple Access with Collision Avoidance |
| CSMA/CD | Carrier Sense Multiple Access with Collision Detection |
| CTS | Clear to Send |
| DCF | Distribution Coordination Function |
| DFS | Dynamic Frequency Selection |
| DHCP | Dynamic Host Configuration Protocol |
| DIL | Direct Link |
| DL | Downlink |
| DS | distribution system |
| DSSS | direct sequence spread spectrum |
| EIRP | Effective Isotropically Radiated Power |
| ESS | Extended Service Set |
| Ethernet | A LAN protocol. See IEEE 802.2 |
| ETSI | European Telecommunications Standards Institute |
| FCC | Federal Communications Commission (USA) |
| FCH | Frame CHannel |
| FHSS | Frequency Hopping Spread Spectrum |
| FSRs | Frequency Sharing Rules |
| GFSK | Gaussian Frequency Shift Keying |
| GHz | GigaHertz |
| GMSK | Gaussian Minimum Shift Keying |
| HIPERLAN | High Performance Radio Local Area |
| | Network (“HL2”, “H2”) |
| HL2 | HiperLAN/2 |
| IBSS | Independent Basic Service Set |
| IEEE 802.11 | Wireless LAN protocol (“11a”) |
| IEEE 802.2 | Ethernet protocol |
| IEEE | Institute of Electrical and Electronics Engineers |
| IETF | Internet Engineering Task Force |
| IP | Internet Protocol |
| IPSec | Internet Protocol security |
| ISA | Integrated Services Architecture |
| ISM | Industry, Scientific, and Medical |
| ISO | International Organization for Standardization |
| km | kilometer |
| LA | Link Adaptation |
| LAN | Local Area Network |
| LLC | Logical Link Control |
| MAC | Media (or Medium) Access Control |
| MIB | management information base |
| MKK | Radio Equipment Inspection and Certification |
| | Institute (Japan) |
| MMAC | Multimedia Mobile Access Communications |
| ms | millisecond |
| MTs | Mobile Terminals |
| mW | milliWatt |
| NAV | network allocation vector |
| NIC | network interface card |
| NOS | network operating system |
| OFDM | Orthogonal Frequency Division Multiplexing |
| PC | Personal Computer |
| PCF | Point Coordination Function |
| PCI | Peripheral Component interconnect |
| PDU | Protocol Data Unit |
| PHY | physical |
| PPM | Pulse Position Modulation |
| PRNG | pseudo random number generator |
| QAM | quadrature amplitude modulation |
| QoS | Quality of Service |
| QPSK | Quadrature Phase Shift Keying |
| RACH | Random Access Channel |
| RC4 | Ron's Code or Rivest's Cipher |
| RCH | Random CHannel |
| RIS | ready-to-send (or Request to Send) |
| SEA | Spokesman Election Algorithm |
| SNMP | Simple Network Management Protocol |
| STA | Station (802.11) |
| TCP/IP | Transmission Control Protocol/Internet Protocol |
| TDD | Time Division Duplex |
| TDMA | Time Division Multiplex |
| TPC | Transmitter Power Control |
| UL | Uplink |
| UMTS | Universal Mobile Telecommunications System |
| U-NIT | Unlicensed National Information Infrastructure |
| W | Watt |
| WECA | Wireless Ethernet Compatibility Alliance |
| WEP | Wired Equivalent Privacy |
| WLAN | Wireless Local Area Network |

### SUMMARY OF THE INVENTION

What is needed is a unified communications protocol for wireless local area networks (WLANs) which provides for the fair co-existence of the 11a and HL2 broadband communications standards. These two incompatible standards are planned to operate on the same frequency bands, leading to incompatible products and impossible interoperability between the two environments. As the industry has learned in the past, multiple standards, product incompatibilities and poor interoperability impose a major hurdle for wide public acceptance.

The present invention provides such a unified communications protocol which ensures that these two standards may fairly co-exist, without being able to communicate with one another and without exchanging resource requests or grants, and which allows each system the opportunity to protect their active terminal (MT) during communication phases and to guarantee a certain Quality of Service (QoS).

According to the invention, a technique is provided for combining the 11a and HL2 standards, enabling protocol co-existence, and improved interoperability between these two WLAN standards, thereby providing a globally-harmonized, synergistic 5 GHz Wireless LAN solution. The principle is generally to combine the best from the two standards, while maintaining one coherent, and relatively simple solution. Broadly stated, the ultimate object of the present invention is providing a unified standard which fulfills the following conditions:

Achieving all-around interoperability, wherein the same device is able to connect, be serviced and to serve in any of the home, office and public environment. The products co-exist and share infrastructure and resources.

Delivering all the required functionality without sacrificing simplicity. Modern Wireless LAN applications require various advanced features, including the ability to deliver wide variety of protocols (e.g., Ethernet, IP, IEEE 1394, and others), quality of service (QoS) support, and robust privacy support (encryption, authentication). Regulations in many countries require radio link functionality for dynamic frequency selection and transmission power control. All those features are integrated into the unified standard of the present invention, without overloading the system with unnecessary complexities, keeping the standard as simple to use and implement as possible.

The present invention can be implemented in a stepwise manner that is suitable to be introduced in phases, each of which may be considered to be an embodiment of the invention, as follows:

Phase 1 This phase enables Co-existence and partial interoperability of both the 11a and HL2 standards at minimum development effort, and divided into two sub-phases:

Phase 1.1 This sub-phase is based on the original APs (E-AP & M-AP) with a partial arbitrator entity (ARB) added to one of the APs.

Phase 1.2 This sub-phase is based on one U-AP.

Phase 2 This phase enables co-existence and full interoperability of both the 11a and HL2 standards

Generally, in the first phase, there is one standard, with partial interoperability among different environments. The PHY layer is 11a, and the MAC layer is essentially a simplified version of HL2 superimposed upon the basic 11a MAC. This results in:

High QoS

Full Co-existence

Partial Interoperability

Generally, in the second phase, there is universal (global) standard. The PHY layer is 11a, and the MAC layer is a hybrid (combination) of HL2 and 11a. This results in:

High QoS

Full Co-existence

Full Interoperability

In the first phase (or “intermediate solution”), co-existence is achieved between the two standards by dynamically dividing the time domain of each subnetwork at its Access Point (AP), between the 11a and the HL2 devices. The tine division between these different devices is performed by an Arbitrator (ARB) entity. For example, this will enable a laptop user working mainly in a corporate environment based on 11a to also connect to and work in his home network, based on HL2. The Arbitrator does not reduce the bandwidth that could otherwise be obtained in either an all-HL2 or in an all-11a subnetwork. This phase is considered to be “partial” because the ARB only controls the time slices. This can be implemented in the wireless network with either:

two separate AP's, one for each environment, each including the ARB entity; or:

one integrated AP servicing both environments, and including the ARB entity.

In the intermediate solution, partial interoperability is achieved by connections, which may be wire-line connections, between the 11a (Ethernet-like) AP and the HL2 (Multimedia) AP. These APs will handle the bridging between the environments.

In the second phase (or “full solution”), there is a unified AP (J-AP) and there are two kinds of wireless terminals (MTs):

E-MTs, which are simple Ethernet-like devices which support only Ethernet environments; and

U-MTs, which are hybrid devices that support both Multimedia and Ethernet. Since U-MTs can talk to E-MTs, full interoperability is achieved.

In the full solution, it is required that all stations (Multimedia and Ethernet) communicate with the U-AP. For example, there could be a need for a laptop, which is an Ethernet-type device, to be able to connect in the home network, which is a multimedia environment.

In this manner, convergence is provided between 11a and HL2, providing users with the best of both worlds, e.g., full interoperability, QoS and co-existence.

According to the invention, a method of enabling wireless network devices (MTs), operating in accordance with two incompatible communications standards, to co-exist without interference, comprises partitioning a periodic time domain into a first slice for use by devices (E-MTs) operating in accordance with a first communications standard, and a second slice for use by devices (M-MTs) operating in accordance with a second communications standard, and broadcasting the time slices to the MTs. The first communications standard consists essentially of the IEEE 902.11 a (“11a”) standard, and the second communications standard consists essentially of the HiPerLAN/2 (“HL2”) standard.

According to a feature of the invention, an Arbitrator entity (ARB) broadcasts the time slices, either once every periodic time domain, or periodically at an interval which is greater than the period of the periodic time domain. (The ARB message is transmitted fewer than once every period.)

According to a feature of the invention, guard periods are introduced between the two slices to prevent overlapped operation of E-MTs and M-MTs. These time slices may be substantially equally partitioned, or may be unequally allocated based on activity of the wireless network devices (MTs).

According, to a feature of the invention, E-MTs are prevented from transmitting outside of the first time slice. This may be accomplished by setting all other time slices in the time domain as busy in a network allocation vector (NAV) of the first communications standard.

According to a feature of the invention, data frames being sent by an E-MT which are larger than its allocated time slice may be fragmented for transmission during a plurality of time slices. A small fragment size may be forced on the data frames of the E-MTs; and a guard time (contention-free period) may be provided before the second time slice, wherein the guard time is sufficient for the E-MT to send one small sized fragment.

In an embodiment of the invention, a first Access Point (E-AP) is provided for handling communications with the E-MTs in an Ethernet environment, and a second Access Point (M-AP) is provided for handling communications with the M-MTs in a multimedia environment. A communications link is provided between the E-AP and the M-AP, thereby providing an intermediate solution.

In another embodiment of the invention, a unified Access Point (U-AP) is provided for communicating with the E-MTs and the M-MTs in a multiple (Ethernet plus multimedia) environment, thereby providing a full solution.

Other objects, features and advantages of the invention will become apparent in light of the following description thereof.

### BRIEF DESCRIPTION OF THE DRAWINGS

Reference will be made in detail to preferred embodiments of the invention, examples of which may be illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

The structure, operation, and advantages of the present preferred embodiment of the invention will become further apparent upon consideration of the following description, taken in conjunction with the accompanying figures, wherein:

FIG. 1 is timing diagram of an embodiment of a unified protocol combining the 11a and HL2 standards, with partial interoperability, according to the invention;

FIG. 2 is timing diagram of an alternate embodiment of a unified protocol combining the 11 a and HL2 standards, with frill interoperability, according to the invention;

FIG. 3 is a graphic illustration of a 2 ms time frame divided into 2 equal parts, one (0.88 ms) containing Ethernet contents, and the second (0.88 ms) containing Mlultimedia content, and a part (0.24 ms) devoted to H2 Management (“H2 Mgmt”), according to the invention;

FIG. 4 is a graphic illustration of a wireless communications network implementing a “partial” solution, wherein some of the MTs operate in the Multimedia environment and other of the MTs operate in the Ethernet environment, according to the invention; and

FIG. 5 is a graphic illustration of a wireless communications network implementing a “full” solution, wherein all of the MTs are Universal MTs (U-MTs) operating in a Multiple (Multimedia plus Ethernet) environment, according to the invention.

### DETAILED DESCRIPTION OF THE INVENTION

By providing co-existence between the 11a and HL2 standards (protocols), the same wireless network can be shared by data communication centric devices using the 11a protocol and by multimedia centric devices using the HL2 protocol for QoS support.

As the ultimate objective of the unified protocol of the present invention is gaining full interoperability between the different operational environments, features of the individual 11a and HL2 standards are eliminated which may jeopardize full interoperability. The 11a standard is pretty much “self interoperable”—in other words, there are no “operation environments” or special considerations regarding the ability to operate any 11a device in an ad-hoc or infrastructure network. The HL2 standard introduced the concept of different operation environments (or profiles), optimizing the ability of specific devices to operate in the home, business (office) or public environments, using different operation extensions. In the “business” profile, HL2 may be used as part of a corporate network dominated by Ethernet traffic, and is used as a wireless Ethernet. In the “home” profile, HL2 may be used for home networking, and both data and multimedia (audio and video) applications are using the channel—for example, internet connection and cordless phones both using HL2 as the transport layer—and a high degree of Quality of service is very important in these environment. In the “public” profile, HL2 may be used in airports, shopping centers and hotels where the applications are both data networking (as in the business profile) but can also be UMTS and other multimedia traffic. Billing, access control and security have high importance in the public profile.

This partitioning to different environments provides some optimization for devices targeted for specific applications, but only at the expense of interoperability. Therefore, as an initial step towards achieving full interoperability of devices, the present invention consolidates the three different HL2 operation profiles, into one “unified” profile, preferably based on the “home” extension of the operational environment. This unified profile support the necessary QoS, IEEE 1394 and ad-hoc networking features, with business Ethernet support provided by the 11a co-existent features, thereby eliminating the need to incorporate the business profile extensions. The use of a single all-around operation profile ensures high degree of interoperability.

According to a first, basic embodiment of the invention, a simplified version of HL2 is overlaid onto the basic 11a MAC, and the resulting time domain is divided (partitioned, allocated) between 11a and HL2 devices. For each protocol the “first” slice of the time is used as dictated by the respective standard, while the “second” slice of the time is forbidden to use by that standard. The partitioning of the time between the protocols is exclusive. An “arbitrator” (ARB) entity manages and broadcasts the time slices provided for each of the protocols, dividing the time domain between the 11a and HL2 slices. The ARB entity may be either of the 11 a or HL2 access points (APs), a separate central controller (CC), or any one of the wireless stations (MTs) in the network.

The 11a devices (MTs) are capable of interpreting the broadcast delivered by the arbitrator (ARB), such that no 11a device transmits outside the allocated 11a time slice. These periods are dealt with like contention-free periods. Within the 11a time slice, the normal 11a protocol may be used, and both DCF and PCF modes may be incorporated. Guard periods may be introduced to guard between the 11a and HL2 time domains, in order to prevent overlapped operation of HL2 and 11a devices, caused by synchronization faults.

The HL2 central controller (TDMA manager, “CC”) is capable of interpreting the broadcast message delivered by the ARB, and to allocate HL2 frames such that no HL2 device is allowed to transmit outside the allocated HL2 time slice.

As specific time slice allocation between the 11a and HL2 domains impose great impact on overall performance, different sorts of dynamic allocation and policy-based solutions may optionally be incorporated by the ARB entity to enable allocating sufficient resources for QoS-bound traffic while leaving additional bandwidth for data communication traffic. Incorporating policy, based on traffic management solution, will allow limiting both data communication and multimedia traffic usage by user configuration. When a reasonable time slice allocation policy is used, the unified protocol of the present invention does not impose any significant bandwidth degradation compared to current bandwidth capabilities available in either of the 11a or HL2 standards.

The HL2 protocol relies heavily on two-millisecond periodic frame generation. On the other hand, the 11a protocol does not impose any specific periodicity restrictions, as long as the 11 a slices are scheduled in close enough tune periods avoiding the generation of higher layer protocol retransmissions, due to timeouts. Since retransmission timeout considerations must be accounted for, the unified protocol of the present invention utilizes the 2-millisecond periodic clocking scheme of the HL2 standard.

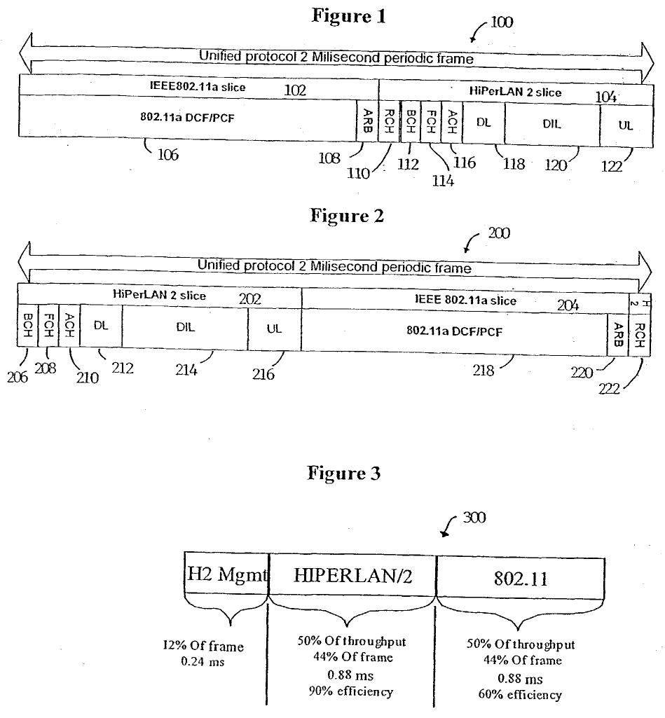

FIG. 1 and FIG. 2 illustrate an embodiment of a unified protocol frame structure of the present invention, from the 11 a viewpoint and from the HL2 viewpoint, respectively. It should be understood that the frame layout is only an exemplary one of many possible embodiments which can be implemented.

FIG. 1 illustrates the scheduling layout (frame structure) of a unified protocol 100 combining the 11 a and HL2 standards, with partial interoperability, from the 11 a viewpoint, according to the invention. An overall periodic frame, having a duration of approximately 2 ms, is divided into two slices, an 11a slice 102 followed by an HL2 slice 104. A number of functions are performed during the periodic frame, as follows (and as tabulated hereinbelow, in Table 1):

A first portion 106 of the 11a slice 102 is dedicated to the DCF and PCF functions, and has a duration of approximately 1.10 ms. A second portion 108 of the 11 a slice 102 is dedicated to the ARB function, and has a duration of approximately 0.06 ms.

A first portion 110 of the HL2 slice 104 is dedicated to the RCH function, and has a duration of approximately 0.06 ms. A second portion 112 of the HL2 slice 104 is dedicated to the BCH function, and has a duration of approximately 0.06 ms. A third portion 114 of the HL2 slice 104 is dedicated to the FCH function, and has a duration of approximately 0.06 ms. A fourth portion 116 of the HL2 slice 104 is dedicated to the ACH function, and has a duration of approximately 0.06 ms. A fifth portion 118 of the HL2 slice 104 is dedicated to the DL function, and has a duration of approximately 0.12 ms. A sixth portion 120 of the HL2 slice 104 is dedicated to the DIL function, and has a duration of approximately 0.32 Ms. A seventh portion 122 of the HL2 slice 104 is dedicated to the UL function, and has a duration of approximately 0.16 ms.

TABLE 1

| Slice/function | milliseconds (ms) |
|---|---|
| 11a slice | 1.16 |
| DCF/PCF | 1.10 |
| ARB | 0.06 |
| HL2 slice | 0.84 |
| RCH | 0.06 |
| BCH | 0.06 |
| FCH | 0.06 |
| ACH | 0.06 |
| DL | 0.12 |
| DIL | 0.32 |
| UL | 0.16 |

As shown in FIG. 1, the 11a time slice 102 comprises a “regular” DCF/PCF period 106 followed by a special ARB broadcast message 108 announcing the start point and length of the following DCF/PCF period. The 11a stations are not allowed transmission outside the DCF/PCF periods, inside those periods the regular 11a rules fully apply. The HL2 protocol is using the allocated bandwidth as broadcasted in the FCH message; the HL2 CC must not schedule HL2 traffic outside the HL2 slice. The presented example is best suited for cases in which the 11 a access point (AP) is used as the HL2 central controller (CC) entity and the arbitrator (ARB), as close synchronization is required between the ARB and the CC entities.

FIG. 2 illustrates the scheduling layout (frame structure) of the unified protocol 200 combining the 11a and HL2 standards, with partial interoperability, from the HL2 viewpoint, according to the invention. An overall periodic frame, having a duration of approximately 2 ms, is divided into two slices, an HL2 slice 202 followed by an 11a slice 204. A number of functions are performed during the periodic frame, as follows (and as tabulated hereinbelow, in Table 2).

A first portion 206 of the HL2 slice 204 is dedicated to the BCH function, and has a duration of approximately 0.06 ms. A second portion 208 of the HL2 slice 204 is dedicated to the FCH function, and has a duration of approximately 0.06 ms. A third portion 210 of the HL2 slice 204 is dedicated to the ACH function, and has a duration of approximately 0.06 ms. In contrast with the protocol of FIG. 1, in this protocol, the RCH function is located at the end of the 11a slice. However, this being a periodic frame, the end of the 11a slice is essentially comparable to the beginning of the next HL2 slice.

A fifth portion 212 of the HL2 slice 204 is dedicated to the DL function, and has a duration of approximately 0.12 ms. A sixth portion 214 of the HL2 slice 204 is dedicated to the DIL function, and has a duration of approximately 0.32 ms. A seventh portion 216 of the HL2 slice 204 is dedicated to the UL function, and has a duration of approximately 0.16 ms. The order of the DL, DIL and UL functions is the same as for the protocol of FIG. 1. However, the DIL function is shown as having been lengthened (prolonged). In striving to make the unified profile resemble as much as possible the “home” profile, which makes extensive use of DIL, the DIL may be prolonged.

A first portion 218 of the 11a slice 204 is dedicated to the DCF and PCF functions, and has a duration of approximately 1.10 ms. A second portion 220 of the 11a slice 204 is dedicated to the ARB function, and has a duration of approximately 0.06 ms. The order of the DCF/PCF and ARB functions is the same as for the protocol of FIG. 1.

Finally, after the end of the 11a slice, a portion 222 of the overall frame is dedicated to the RCH function.

TABLE 2

| Slice/function | milliseconds (ms) |
|---|---|
| HL2 slice | 0.90 |
| BCH | 0.06 |
| FCH | 0.06 |
| ACH | 0.06 |
| DL | 0.12 |
| DIL | 0.40 |
| UL | 0.16 |
| 11a slice | 1.04 |
| DCF/PCF | 0.98 |
| ARB | 0.06 |
| RCH | 0.06 |

### Abbreviations Used in the Table 1 and Table 2

| | |
|---|---|
| DCF | Distribution Coordination Function |
| PCF | Point Coordination Function |
| DL | Downlink |
| UL | Uplink |
| DIL | Direct Link |
| ACH | Access feedback CHannel |
| BCH | Broadcast Channel |
| FCH | Frame CHannel |
| RCH | Random Channel |

It is evident that the unified protocol of the present invention incurs a “cost”, per se, by adding “management” information which is transmitted by the ARB entity in order to synchronize the 11a and HL2 time slices. However, the impact is surprisingly minimal.

By dividing a 2 ms time frame into 2 equal parts, one containing Ethernet content and the second multimedia content, a frame created is as shown in FIG. 3. A third portion (or slice) of the frame is allocated to management (H2 Mgmt, ARB broadcast).

Assume, for example, that Ethernet (11a) utilization with frames of typical length (300 bytes) and a 10 stations network is about 60%. It can be shown that HL2, under the same conditions, achieves about 80% efficiency for the data transfer. This 80% efficiency is the result of the following: 12% of the HL2 MAC frame is dedicated to management (Frame header-BCH, FCH, ACH and RCH). In addition, data overhead is about 10% (CRC, SAR, LCH header). Therefore:

(1−0.12)×(1−0.1)=0.792?0.8 (80% efficiency).

By dividing a 2 ms time frame into 2 equal parts, one containing Ethernet content and the second multimedia content, a frame created is as shown in FIG. 3. The resulting channel efficiency is: (0.44×90%)+(0.44×60%)=66%, which is slightly better (no worse than) than the aforementioned 60% channel efficiency for Ethernet-only channel utilization, and which is slightly worse than the aforementioned 80% channel efficiency for HL2-only channel utilization.

However, this slight deficiency can be remedied. For example, if Ethernet contents are passed without multimedia, the HL2 management information need not be transmitted once in every unified frame. Rather, the HL2 management information can be transmitted every 500 ms or more, since this information will be needed for association only. In this manner, the cost of interoperability can be decreased to less than 1% of channel time. (Without the existence of HL2 connections the management information part is only 2.2%.)

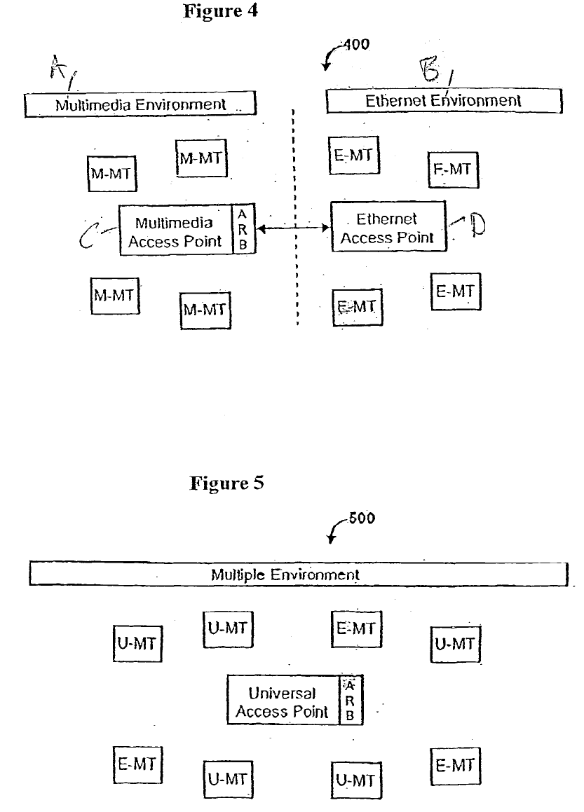

FIG. 4 illustrates an embodiment of a wireless communications network 400 implementing a “partial” solution, such as has been discussed hereinabove. In this example, a first portion of the MTs operate in the Multimedia (HL2) environment and are labeled “M-MT”, a second portion of the MTs operate in the Ethernet (11a) environment and are labeled “E-MT”. A Multimedia AP communicates with the M-MT's. An Ethernet AP communicates with the E-MTs. The M-MTs can communicate with one another. The E-MTs can communicate with one another. The M-MTs cannot communicate directly with E-MTs, and vice-versa. An Access Point (AP) is provided in each of the Multimedia (HL2) and Ethernet (11a) environments. An arbitrator function (ARB) is provided in the Multimedia AAP for managing interactions.

In this embodiment, the wireless network includes two separate APs, one for each environment (Multimedia and Ethernet). The two separate APs, an Ethernet AP (E-AP) and a Multimedia AP (M-AP) communicate with one another via a communications link, such as via land-lines or over an air channel, functioning as a bridge between the two APs. The ARB is illustrated as being implemented in the M-AP, and it is “partial” because it doesn't include the full AP mission, but only exercises control over the time slices. It is within the scope of the invention that the ARB could be implemented in the E-AP. It is within the scope of the invention that the ARB can include the missions of both environments.

FIG. 5 illustrates an embodiment of wireless communications network 500 implementing a “full” solution, such as has been discussed hereinabove, in a Multiple (Multimedia plus Ethernet) environment. The Multiple Environment is also referred to as a “Harmonized Network”.

In this example, there is a unified AP (U-AP) which can communicate with U-MTs, as well as with E-MTs. Since the U-MTs can communicate with the E-MTs, there is full interoperability. In this solution, there are preferably no M-MTs. The U-MTs can communicate with one another. The E-MTs can communicate with one another, but not with U-MTs. The ARB is shown as being implemented in the U-MT.

### The Arbitrator (ARB)

The Arbitrator (ARB) entity is responsible for partitioning the time domain between protocols. It can be combined with the E-AP or with the M-AP. It can be selected dynamically (as in dynamic HL2 CC election). The protocol partitioning may be policy based and dynamic to ensure maximal efficiency. The 11a and HL2 devices must transmit only inside their allocated time slices.

The ARB is required to be present on the harmonized network at all times. Its task is to partition the time domain between the 11a and HL2 protocols. The partitioning is performed by applying policy-based algorithms, and/or protocol utilization measurements for both 11a and HL2 sub-networks. The arbitrator entity generates the ARB broadcast message, instructing 11a and potentially the HL2 central controller (CC) for available time slices for the respective protocols.

The ARB's complexity is dependant on the employed scheduling algorithm and arbitrator management scheme. The management scheme is discussed hereinbelow. As for the scheduling algorithm, its complexity may vary in accordance to applicable requirements. A static arbitrator is relatively straightforward to implement. A dynamic arbitrator would be a bit more complex. Perfecting the algorithm beyond a reasonable level is not desirable because it would produce a highly complex algorithm, which would only be marginally superior.

The information that a typical ARB may use is the number of stations (MTs) in the network, traffic utilization and number of resource requests denied by the HL2 CC. Using these parameters and a set of configurable rules (via SNMP or other management protocol) the arbitrator (ARB) can update the resource allocation demands.

The management functions of the arbitrator entity bear some resemblance to the work done in BRAN considering central controller (CC) behavior in the HL2 ad-hoc network scenario, namely procedures for CC election, handover between CCs and other related issues.

In situations of monolithic networks—namely, those in which all the network activities are based on only one of the two underlying protocols (11a or HL2), the inclusion of ARB message in each 2-millisecond period, might be considered as unnecessary. In these situations, it is preferred that the ARB message is transmitted once every longer time periods (each 500 milliseconds for example), and that arbitrator will allocate a minimal time slice for the other protocol, to allow the association of devices using that protocol. For 11a, the time period will include the probe message, and a delay to allow authentication and associations request generation by STAs (MTs). For the HL2 protocol the time period will include the generation of a BCH, minimal FCH (no allocation of traffic), minimal ACH and the RCH to allow association of mobile terminals. Upon association request, and start of traffic transfers, the arbitrator shall increase the time slices allocated for that protocol. This scheme will optimize traffic utilization of monolithic networks, in the cost of prolonging the association process.

Generally speaking, the arbitrator entity (ARB) does not need to support both the 11a and HL2 standards. Therefore, it is possible to implement a simple protocol by which both the HL2 CC and one of the 11a STAs (F-MT) are reporting to the arbitrator (ARB). For example, in a typical implementation (e.g., Phase 1.2 or 2.0), the 11a AP (E-AP) will serve as both the HL2 CC and the ARB, combining all the functionality in one device. It is clear that in this case the ARB will have a good picture of traffic utilization and requirements for the different protocols, and there is no need for having a specific reporting protocol. Another added value from such a configuration is the ability to gain interoperability between the 11a and HL2 devices through the use of the AP as a relay.

### Home, Office and Public Environment Interoperability

Interoperability between the various operational environments is achieved by using the same unified protocol on all environments. This ensures co-existence of devices intended for the different operational scenarios, so that both can work and share the same band. To further enable higher levels of communication between devices using the 11a and HL2 protocols, it is also possible to use an optional network entity that is able to recognize both protocols. In the typical case it will be the 11a/HL2 access point/central controller (AP/CC). This entity would provide protocol translation facilities to enable data transfer between HL2 and 11a devices.

Typically, office data-communication centric devices will use the 1a protocol, and home multimedia centric devices will use the HL2 protocol. Although the partitioning described hereinabove covers the main part of these devices activities, it is important to allow data communication devices some degree of QoS support, and to allow multimedia devices the ability to use asynchronous communications for control and other purposes. One solution is to require each device to support both protocols.

Currently QoS extensions to the 11a MAC protocol are being defined. It is preferred that a definition of “light QoS” be introduced, enabling support for the 802.1p/q, RSVP and other wired data communications equivalent QoS extensions. Modifications of the 11a MAC to support “light QoS” will not introduce unnecessary complications to the protocol. “Light QoS” provides most business requirements for QoS, as it delivers the ability to support their wired equivalents. These will enable business devices to maintain the simplicity and remain 11a based.

The current multi-profile nature of HL2 (currently business and home extension profiles are introduced) limits interoperability. As different protocol options are applied in the different profiles, devices built by different profiles will have great difficulties, or even will not succeed in communicating. As the 11a standard provides robust and simple solution for business devices, it is preferred to simply eliminate the business and public profiles, and establish the single HL2 profile used in the unified protocol on the basis of the “HL2 home extensions”. The home extensions to the HL2 protocol deliver QoS, IEEE 1394 and ad-hoc networking supported all are major prerequisites for the unified protocol of the present invention. As signaling and non-QoS traffic concepts are already integrated into the HL2 protocol, enabling them for multimedia devices inside HL2 is a non-issue.

### Fragmenting Large 11a MAC Frames

In some cases, such as when using a slow transmission method, the maximal 11a MAC frame size may be larger than the allocated 2 millisecond time slice. Therefore, according to the invention, the transmission of arbitrary 11a frames is enabled by applying fragmentation. The maximum frame fragment size will be determined by the size of the 11a transmission time slice and the transmission data rate. The minimal slice size value can be specified and distributed around the BSS (During the ARB broadcast for example), and it is guaranteed that any allocated 11a time slice shall not be shorter then this value. When fragmentation is required the fragment size shall be calculated using the minimal slice size. In typical situations (e.g., 16 QAM), a 600-microsecond slice for the 11a protocol can suffice for un-fragmented transmission of a maximal length Ethernet packet. Typically, fragmentation will be avoided.

Fragmentation of multicast and broadcast frames is not normally supported within the 11a standard. Therefore, according to the invention, the 11a MAC is enhanced to support fragmentation of broadcast and multicast messages. On transmission of broadcast or multicast fragments, no acknowledgment is sent, and no retransmission of fragments is supported. This is coherent with un-fragmented multicast and broadcast traffic specifications in 802.11, in which no acknowledgment is supported.

### Small Sized Fragments for 11a E-MTs

Problems can arise from 11a MTs (E-MTs) that do not implement the unified protocol transmitting frames that exceed the unified protocol 11a time slice. Therefore, such E-MTs working within the harmonized network that do not implement the unified protocol, should not transmit beyond the 802.11 time slice. To ensure this, a small fragment size, is forced on the 11a frames of these E-MTs. Also, the HL2 time slice will be preceded by a guard time that will be enough for an E-MT to send one fragment. For example,

fragment size is approximately 100 microseconds; and

guard time is approximately 100 microseconds.

In this manner, the HL2 transmissions will be safe from interference by 11a transmissions that began shortly before the HL2 time slice. Because of this, there will be a contention free period of up to one fragment transmission time, before the HL2 time slice. This frame size should be small enough not to cause channel efficiency to drop. This feature is only relevant to environments accommodating “old” 11a MTs, to ensure backward compatibility. In an environment without older 11a MTs, it can be disabled, or simply ignored.

Preventing an E-MT from Transmitting Outside of the 11a Time Slice

Under existing to 11a MAC rules, if a specific 11a station (STA) starts its transmission (after carrier sensing or CTS in DCF mode, or after being polled by the PC in PCF mode) it will not consider any external timing constrains, and the complete frame (or fragment) will be sent. In order to implement the universal protocol of the present invention, it is therefore necessary ensure that there is no E-MT (STA) transmitting outside the 11a time slice. The existing 11a-MAC functionality supports virtual carrier-sense mechanisms through the concept of NAV (network allocation vector) to predict future traffic on the medium according to duration indications in various frames (RTS/CTS, CP, etc.).

According to the invention, time slices not allocated to the 11a protocol will be set as busy by the 11a-NAV. Each ARB broadcast will update the NAV with the duration of the next HL2 slice and ARB broadcast message, indicating it as “busy”. As all STAs in the BSS or IBSS are not transmitting if there is a NAV traffic indication, all 11a devices will therefore be limited to using only the 11a allocated slices. The notion of “look-ahead NAV” implies that each transmitting STA (MT) must check that the frame size fits inside the allowed slot, and does not collide with a look ahead NAV. If the frame size does not fit into the slot, the STA will suspend the transmission of the frame until the next available slot. Reasonable clock synchronization between the STAs in the BSS can be maintained in order for this mechanism to work, and may be achieved by the beacon and clock synchronization mechanisms available in the 11a-MAC

### Modifications to the HL2 and 11a Protocols

Modifications to the HL2 protocol, to allow protocol co-existence, include changes to the associations process. As it is not promised that each 2 millisecond period a BCCH message will be generated, each device should be able to wait for longer periods on each frequency band. The HL2 central controller (CC) must be synchronized with the arbitrator (ARB), so that time-slice allocations do not collide, the CC scheduling algorithm must be aware of the “occupied” TDMA slots not allocating them to any HL2 device.

Modifications to the 11a protocol, to allow protocol co-existence, include

Enhance the existing fragmentation mechanism, as specified hereinabove; and

Change NAV functionality, so HIPERLAN/2 periods could be registered in 802.11 devices, as “busy” (see above). NAV updates shall be performed by the new ARB message.

Additionally, it is necessary to add “light QoS” support to the 802.11 devices, such as is specified in IEEE 802.1 q/p, RSVP or other, in order to provide for a basic level of QoS, as applicable for business applications. This issue has been discussed hereinabove with respect limiting operation to the, “home” environment. As in the HIPERLAN/2 case, the 802.11 AP/PC shall be able to synchronize with the arbitrator, so that time-allocations do not collide in PCF mode.

### Conclusion(s)

The invention is beneficial in that it combines and enables co-existence between IEEE 802.11a (11a) and HIPERLAN/2 (HL2) protocols. Having one global interoperable 5 GHz standard (universal protocol) will greatly simplify the worldwide adoption of Wireless LAN technology. By using the strongest features of both 11a and HL2, dedicated devices for the various operation environments may share the same network and exchange data, with no major effects on device complexities. The invention provides a feasible framework, generally, for the universal protocol.

One of the most important capabilities enabled by the present invention is keeping each device in the global wireless network as simple as possible. Wireless business devices are based on the field proven and existing 11a standard, ensuring rapid development and low cost. Wireless multimedia is enabled through the clean and robust HL2 standard. No patches and minimal adaptations and modifications are proposed to enable wireless multimedia, and the co-existence between data communication and multimedia.

Another degree of simplicity is achieved by applying a single profile solution for all devices. This ensures that users will not be required to manage separate wireless solutions and to deal with any incompatibility issues. As same wireless network protocols are enabled all over the world, users are not required to maintain several hardware devices or several configurations.

The HL2 standard is full of options, which makes the protocol very adaptive and robust, but increases implementation complexities. Care must be exercised when different vendors implement different options. In these cases, the lowest common denominator approach should preferably be used, which is not desirable for QoS support, error control or privacy, etc. In these cases the lowest common feature may be lack of QoS, lack of Error control, etc. It is important to minimize the available protocol options, to set the required options as mandatory, and to eliminate as much “optional” directive as possible. This can be applied for QoS support (use FSA-fixed a lot allocation method, eliminate FCA-fixed capacity agreement method), error control (set RS and ARQ, eliminate repetition), Privacy (limit the number of possible options for key management and authentication).

Although the invention has been described with respect to a limited number of embodiments, it will be appreciated that many variations, modifications and other applications of the invention may be made, and are intended to be within the scope of the invention, as disclosed herein.

What is claimed is:

1. A method of enabling wireless network devices (MTs), operating in accordance with two incompatible communications standards, to co-exist without interference comprising:
partitioning a periodic time domain into a first slice for use by devices (E-MTs) operating in accordance with a first communications standard, and a second slice for use by devices (M-MTs) operating in accordance with a second communications standard; and
broadcasting the time slices to the MTs; wherein:
the first communications standard consists essentially of the IEEE 802.11 a standard; and
the second communications standard consists essentially of the HiPerLAN/2 standard.

2. Method, according to claim 1, wherein:
the periodic time domain has a duration of 2 ms.

3. Method, according to claim 1, further comprising:
providing a first Access Point (E-AP) for handling communications with the E-MTs in a first environment; and
providing a second Access Point (M-AP) for handling communications with the M-MTs in a second environment.

4. Method, according to claim 3, wherein:
the first environment is an Ethernet environment; and
the second environment is a multimedia environment.

5. Method, according to claim 3 further comprising:
providing a communications link between the between the F-AP and the M-AP.

6. Method, according to claim 1, further comprising:
providing a unified Access Point (U-AP) for communicating with the E-MTs and the M-MTs in a multiple environment.

7. Method according to claim 1 further comprising:
introducing guard periods between the two slices to prevent overlapped operation of E-MTs and M-MTs.

8. Method, according to claim 1, wherein:
the first and second time slices are substantially equally partitioned.

9. Method according to claim 1, further comprising:
broadcasting the time slices to the MTs once every periodic time domain.

10. Method, according to claim 1, further comprising:
broadcasting the time slices to the MTs periodically at an interval which is greater than the period of the periodic time domain.

11. Method, according to claim 1, further comprising:
unequally allocating the time slices, preferentially, based on activity of the wireless network devices (MTs).

12. Method, according to claim 1, further comprising:
fragmenting data frames being sent by an E-MT which are larger than the first slice.

13. Method, according to claim 1, further comprising:
forcing a small fragment size on data frames of the E-MTs; and
providing a guard time (contention-free period) before the second time slice; wherein:
the guard time is sufficient for the E-MT to send one fragment

14. Method, according to claim 1, further comprising:
preventing an E-MT from transmitting outside of the first slice.

15. Method, according to claim 14, wherein:
the E-MT is prevented from transmitting outside of the first slice by setting all other time slices in the time domain as busy in a network allocation vector (NAV) of the first communications standard.

16. Method, according to claim 15, further comprising:
before transmitting a frame, the E-MT checks that the frame size fits inside an allowed slot in the first slice and will not collide with a look-ahead NAV; and
if the frame size does not fit into the first slice, the E-MT suspends the transmission of the frame until the next available slot.

17. A method of enabling wireless network devices (MTs), operating in accordance with two incompatible communications standards, to co-exist without interference, comprising:
partitioning a periodic time domain into a first slice for use by devices (E-MTs) operating in accordance with a first communications standard, and a second slice for use by devices (M-MTs) operating in accordance with a second communications standard;
broadcasting the time slices to the MTs;
providing a first Access Point (E-AP) for handling communications with the E-MTs in an Ethernet environment; and
providing a second Access Point (M-AP) for handling communications with the M-MTs in a multimedia environment.

18. A method of enabling wireless network devices (MTs), operating in accordance with two incompatible communications standards, to co-exist without interference, comprising:
partitioning a periodic time domain into a first slice for use by devices (E-MTs) operating in accordance with a first communications standard, and a second slice for use by devices (M-MTs) operating in accordance with a second communications standard; and
broadcasting the time slices to the MTs;
forcing a small fragment size on data frames of the E-MTs: and
providing a guard time (contention-free period) before the second time slice; wherein:
the guard time is sufficient for the E-MT to send one fragment

19. A method of enabling wireless network devices (MTs), operating in accordance with two incompatible communications standards, to co-exist without interference, comprising:
partitioning a periodic time domain into a first slice for use by devices (E-MTs) operating in accordance with a first communications standard and a second slice for use by devices (M-MTs) operating in accordance with a second communications standard; and
broadcasting the time slices to the MTs; and
preventing an E-MT from transmitting outside of the first slice; wherein:
the E-MT is prevented from transmitting outside of the first slice by setting all other time slices in the time domain as busy in a network allocation vector (NAV) of the first communications standard;
before transmitting a frame, the E-MT checks that the frame size fits inside an allowed slot in the first slice and will not collide with a look-ahead NAV; and
if the frame size does not fit into the first slice, the E-MT suspends the transmission of the frame until the next available slot.
